(19) United States
(12) Patent Application Publication
(10) Pub. No.: US 2010/0128468 A1
(43) Pub. Date: May 27, 2010

(54) SAFETY HELMET

(75) Inventors: Tony ONG, Mississauga (CA); Nan-Sing Chua, Edison, NJ (US)

Correspondence Address: BANNER & WITCOFF, LTD., 1100 13th STREET, N.W., SUITE 1200, WASHINGTON, DC, 20005-4051, US

(73) Assignee: MTO International Specialties, Inc., Mississauga (CA)

(21) Appl. No.: 12/275,533

(22) Filed: Nov. 21, 2008

(51) Int. Cl. F21V 21/084; F21V 23/00; A42B 1/24

(52) U.S. Cl. 362/106; 362/276; 362/105; 2/422

(57) ABSTRACT

An illuminator device that attaches to a safety helmet for providing illumination when a user is moving. The safety helmet includes an exterior surface. The illuminator device includes a fiber optic cable having two ends and adapted for mounting on the safety helmet so as to illuminate an exterior of the safety helmet. The illuminator device includes a light source coupled to a light interface, the light interface connected to one end of the fiber optic cable, the light source being activateable. A motion detector detects motion or motion of a preselected type or amount and provides a signal to activate the light source upon detection of motion or the preselected motion.

### FIELD

The present invention relates generally to safety helmets. More particularly, the present invention relates to a warning illuminator device for safety helmets.

### BACKGROUND

For many sporting activities the participant requires head protection for prevention of head injury and similar occurrences. For example, head protection may be required in high-speed activities such as cycling, roller-blading, skateboarding, etc. If the activity occurs at places or periods of low illumination, such as at dusk or nighttime, the participant may potentially be unseen by others who provide potential hazards, such as being unseen by a driver of a passing vehicle when the participant is cycling or rollerblading.

Some conventional bike helmets include a lamp mounted to the front of the bike helmet to provide illumination for the rider of the helmet to see in front of the riding path. Such helmets are typically driven by a portable power supply such as a battery. As can be appreciated, batteries may provide the requisite power but have a limited lifespan. Batteries are also relatively expensive. Further, some of these lamps emit much of the energy as heat, wasting some of the limited energy capacity of the battery.

In addition, some of these lamp mounted helmets are relatively heavy and may impede the mobility and activities of the participant.

### SUMMARY

It would be advantageous to provide safety helmets which address at least some of the above-noted difficulties.

The present application generally provides an illuminator device that attaches to a safety helmet for providing illumination when moving.

In one aspect, the present application provides an illuminator device for a safety helmet, the safety helmet including an exterior surface. The illuminator device includes a fiber optic cable having two ends and adapted for mounting on the safety helmet so as to illuminate an exterior of the safety helmet, a light source coupled to a light interface, the light interface connected to one end of the fiber optic cable, the light source being activateable, a power source electrically connected to the light source, and a motion detector for detecting motion or motion of a preselected type or amount and for providing a signal to activate the light source upon detection of motion or the preselected motion.

In another aspect, the present application provides a helmet system having a safety helmet and an illuminator device. The safety helmet includes an exterior shell having an exterior surface. The illuminator device includes a fiber optic cable having two ends and mounted on the safety helmet so as to illuminate an exterior of the safety helmet, a light source coupled to a light interface, the light interface connected to one end of the fiber optic cable, the light source being activateable, a power source electrically connected to the light source, and a motion detector for detecting motion or motion of a preselected type or amount and for providing a signal to activate the light source upon motion detection or detection of the preselected motion.

In another aspect, there is provided a method of illuminating a safety helmet having an exterior surface, the safety helmet having a fiber optic cable having two ends mounted thereon so as to illuminate an exterior of the safety helmet. The method includes detecting motion or motion of a preselected type or amount of the safety helmet and providing a control signal upon detection of motion or motion of the preselected type to activate a switch to an active state, and activating a light source coupled to a light interface connected to one end of the fiber optic cable, said light source being activated when said switch is in the active state.

### DESCRIPTION OF THE FIGURES

Embodiments will now be described by way of example with reference to the accompanying drawings, in which like reference numerals are used to indicate similar features, and in which:

FIG. 1A shows an exploded right side view of a safety helmet system in accordance with an example embodiment;

FIG. 1B shows an assembled right side view of the safety helmet system;

FIG. 2A shows an exploded left-front view of the safety helmet system;

FIG. 2B shows an assembled left-front view of the safety helmet system;

FIG. 3A shows an exploded front view of the safety helmet system;

FIG. 3B shows an assembled front view of the safety helmet system;

FIG. 4A shows an exploded left-rear view of the safety helmet system;

FIG. 4B shows an assembled left-rear view of the safety helmet system;

FIG. 5A shows a front view of an illuminator device to be used in the safety helmet system in accordance with an example embodiment;

FIG. 5B shows a bottom view of the illuminator device of FIG. 5A;

FIG. 5C shows a rear view of the illuminator device of FIG. 5A; and

FIG. 6 shows a diagrammatic detail view of the illuminator device of FIG. 5A.

### DETAILED DESCRIPTION

In one example embodiment, there is generally provided an illuminator device that attaches to a safety helmet for providing illumination when moving.

In another example embodiment, there is provided an illuminator device for a safety helmet, the safety helmet including an exterior surface. The illuminator device includes a fiber optic cable having two ends and adapted for mounting on the safety helmet so as to illuminate an exterior of the safety helmet, a light source coupled to a light interface, the light interface connected to one end of the fiber optic cable, the light source being activateable, a power source electrically connected to the light source, and a motion detector for detecting motion or motion of a preselected type or amount and for providing a signal to activate the light source upon detection of motion or the preselected motion.

In another example embodiment, there is provided a helmet system having a safety helmet and an illuminator device. The safety helmet includes an exterior shell having an exterior surface. The illuminator device includes a fiber optic cable having two ends and mounted on the safety helmet so as to illuminate an exterior of the safety helmet, a light source coupled to a light interface, the light interface connected to one end of the fiber optic cable, the light source being activateable, a power source electrically connected to the light source, and a motion detector for detecting motion or motion of a preselected type or amount and for providing a signal to activate the light source upon motion detection or detection of the preselected motion.

In another example embodiment, there is provided a method of illuminating a safety helmet having an exterior surface, the safety helmet having a fiber optic cable having two ends mounted thereon so as to illuminate an exterior of the safety helmet. The method includes, detecting motion or motion of a preselected type or amount of the safety helmet and providing a control signal upon detection of motion or motion of the preselected type to activate a switch to an active state, and activating a light source coupled to a light interface connected to one end of the fiber optic cable, said light source being activated when said switch is in the active state.

In another example embodiment, the signal provided by the motion detector is proportional to the speed of motion. The light source includes an optical property which responds based on the proportional signal provided by the motion detector.

The illustrated safety helmet system 10 generally includes a safety helmet 12 and an illuminator device 14 for attachment to the safety helmet 12. Generally, the illuminator device 14 attaches to safety helmet 12 and provides illumination, for example for warning others when the user is moving.

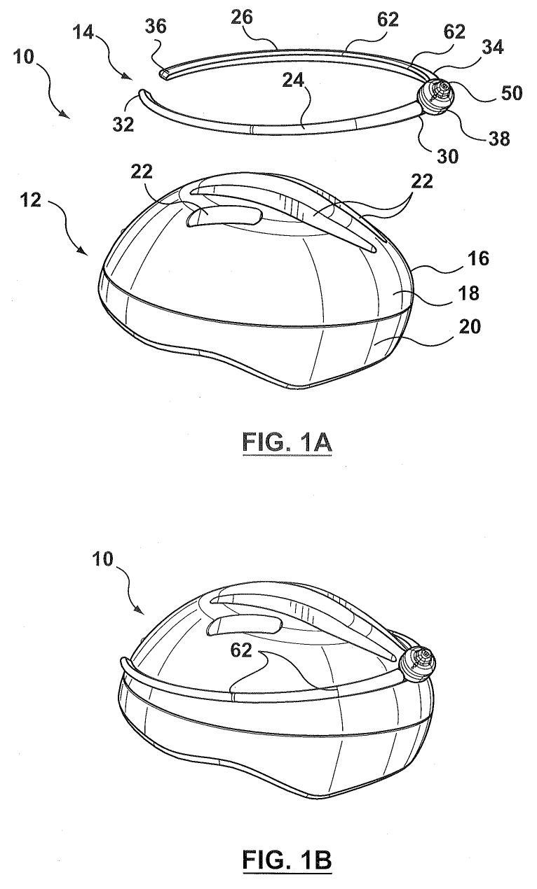

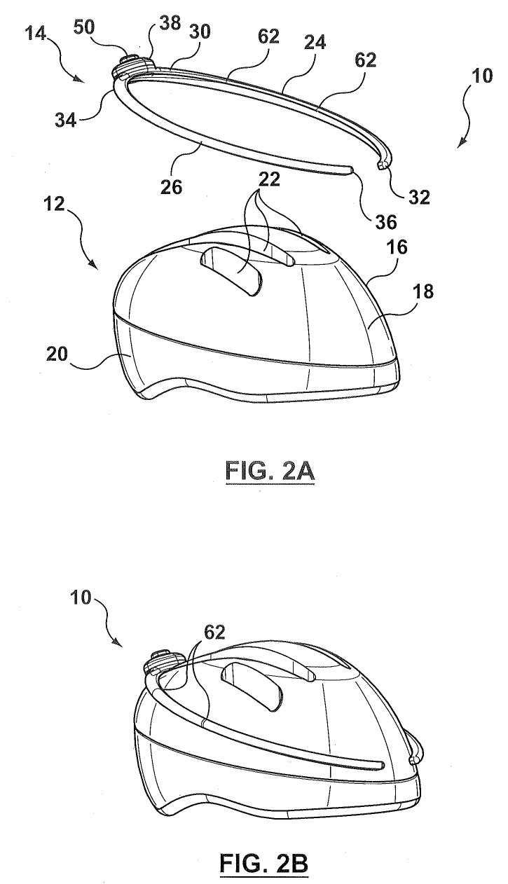

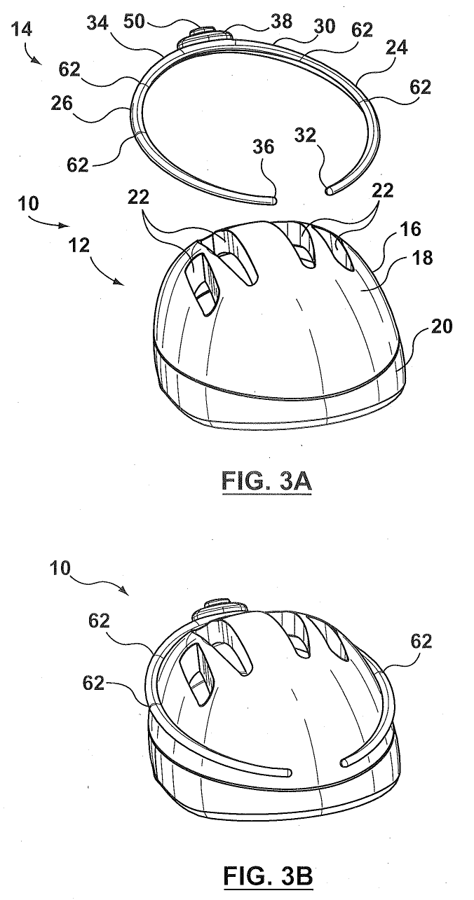

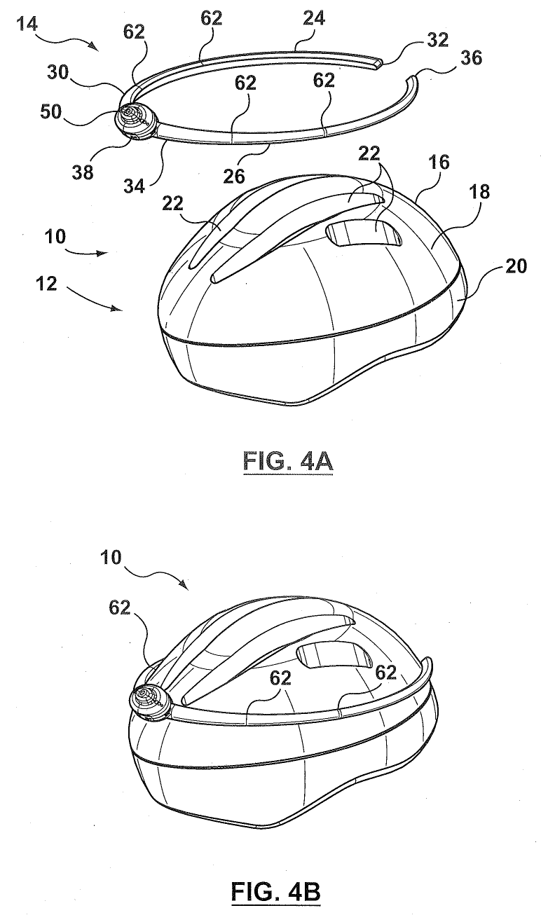

Referring to FIGS. 1 to 4, the safety helmet 12 includes an exterior shell 16 and an interior shell 20. The exterior shell 16 has an exterior surface 18 and is formed of a hard impact resistant material. The interior shell 20 is formed of a high density polystyrene foam. The shape of the interior shell 14 generally conforms to the shape of the exterior shell 16, wherein the two shells 16, 20 can matingly connect with one another. Additional shells may also be provided depending on the desired structure, for example to provide additional protection. As shown, the exterior shell 16 has also defined therein a plurality of air holes 22 which allows passage of air to cool the user when using the safety helmet 12. A chin strap (not shown) may also be connected to the exterior shell 16, as is known in the art.

The illuminator device 14 attaches to the exterior surface 18 of the safety helmet 12. The illuminator device 14 includes first and second fiber optic cables 24, 26 which are positioned along the exterior surface 18. First optic cable 24 includes first end 30 and second end 32. Similarly, the second optic cable 26 includes first end 34 and second end 36. A casing 38 is also mounted to the safety helmet 12 and receives the first ends 30, 34 of the optic cables 24, 26. As shown, the casing 38 is mounted generally at the rear of the safety helmet 12 and the optic cables 24, 26 extend along a circumference of the safety helmet 12.

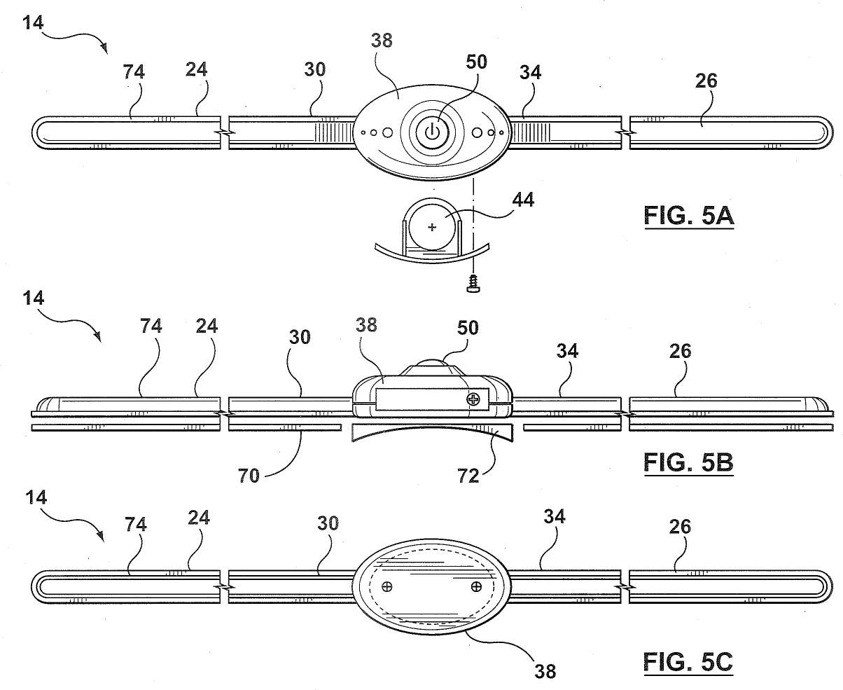

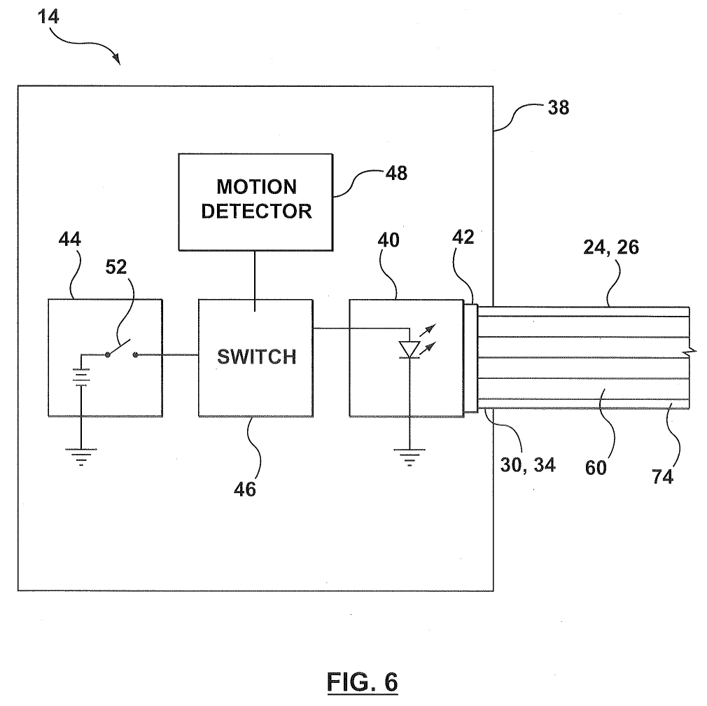

Reference is now made to FIG. 6, which illustrates a diagrammatic detail view of the illuminator device 14. Housed within the casing 38 are a light source 40 coupled to a light interface 42, a power source 44, a switch 46, and a motion detector 48. The light interface 42 is connected to the first ends 30, 34 of the fiber optic cables 24, 26. The light source 40 is activateable by way of switch 46, which may be activated by an appropriate signal. The power source 44 is electrically connected to the light source 40. The motion detector 48 is used for detecting motion and for providing a signal to activate the switch 46 (and thereby the light source 40) upon motion detection. A hard button 50 (FIG. 5) is also provided on the casing 38 which is coupled to hard switch 52 for manually powering on and off of the illuminator device 14. As shown, the hard switch 52 may be directly connected to the power source 44.

Referring still to FIG. 6, the fiber optic cable 24, 26 includes a plurality of individual optical fibers 60 which are bundled in a plastic or rubber tube-like casing 74. As will be understood in the art, each optical fiber 60 acts as a cylindrical dielectric waveguide that transmits light along its axis, by the process of total internal reflection. The optical fiber 60 includes a core surrounded by a cladding layer. As can be appreciated, to confine the optical signal in the core, the refractive index of the core is greater than that of the cladding. The light interface 42 provides an appropriate entry angle for the light source 40 to allow entry of the light into the optical fibers 60.

Referring to FIG. 6, in some example embodiments, each optical fiber 60 of the fiber optic cable 24, 26 can be what is referred to as a point-to-point optical fiber. Generally, no light emits out of the cladding of a point-to-point optical fiber. In a point-to-point optical fiber, light enters into the first end 30, 34 of the fiber optic cable 24, 26 for each optical fiber 60. As best shown in FIGS. 1 to 4, some of the individual optical fibers 60 are positioned to have their respective light emitting ends 62 located at different positions along the length of the fiber optic cable 24, 26. The light within each optical fiber 60 emits from its end 62 to provide illumination. Illumination is thereby provided at spaced apart regions along the fiber optic cable 24, 26. This may for example result in 360 degree illumination of the helmet system 10.

Referring to FIG. 6, the motion detector 48 detects motion or movement of the helmet system 10 when moving. The motion detector 48 includes one or more sensors which detect changes in movement, speed or acceleration. The motion detector 48 detects motion and determines that the light source 40 should be activated. Therefore, once motion is detected, the motion detector 48 provides a signal to the switch 46. In some example embodiments, the motion detector 48 determines whether the movement exceeds a predetermined threshold of movement. For example, the motion detector 48 can include a cylinder capsule like component. Inside the capsule is a metal ball and spring. The capsule also has a two-wire connection, representing positive and negative polarity. When the motion detector 48 is not in motion, the wires are separated. When the motion detector 48 is in motion, the metal ball will slide up and down (or from one end to the other of the cylinder capsule), thereby connecting the wires together. This closes the circuit and provides the signal to the light source 40. In some example embodiments, the motion detector 48 includes an accelerometer to provide a signal once a predetermined acceleration threshold is exceeded. In other example embodiments, the motion detector 48 provides a variable signal based on the speed of movement. In such embodiments, the motion detector 48 for example includes an optical sensor, for example an infrared sensor with a sensor face having an array of infrared sensors arranged in a spatial orientation, for example a grid-like arrangement. The array is directed externally, for example positioned to point to the ground. The sensor face receives image signals from various articles or particles (for example stone, grass, paint, etc.) at different infrared sensors in the array. This information is processed for determining any change in each infrared sensor in the array and a differential change results in a signal provided to the switch 46. In some example embodiments, a differential amplifier is used to detect any change in a given infrared sensor, which provides an increased signal (e.g. voltage or current) in proportion to the amount of movement or speed detected.

The power source 44 can for example be a DC (direct current) source such as a battery. A lithium battery such as a CR-2032×2 can for example be used for its portability, weight and relatively long life.

Referring to FIG. 6, in some example embodiments, the switch 46 can be a controller, microcontroller, logic chip, computer, electromechanical, or electrically based mechanism to receive the signal from the motion detector 48 and effect activation of the light source 40. The switch 46 can for example be a transistor which is activated by a current signal as provided by the motion detector 48. In some example embodiments, the switch 46 includes a variable mechanism or module for receiving a signal or control signal, and for activating a frequency of flashing of the light source 40 in proportion to the received signal. In some example embodiments, the switch 46 is not necessarily a separate component or module, and in such embodiments the motion detector 48 can include its own mechanism for driving or activating of the light source 40. It can be appreciated that use of the switch 46 may decrease energy consumption of the power source 44 when compared to continuous illumination.

The light source 40 may for example be a LED (Light Emitting Diode), to provide illumination and visibility to the exterior of the safety helmet 12. The LED can include one or more set of wavelengths. The LED can for example be a flashing LED, which provides a flashing illumination even though a constant direct current is applied for activation. In some example embodiments, as described above, the LED receives a stronger signal when there is increased motion or speed detected by the motion detector 48. The frequency of flashing of the LED is proportional to the received signal from the motion detector 48 or switch 46. The faster the movement, the faster the frequency of flashing. Thus, others may be aware of the general speed of the user. A microcontroller (not shown) may also be used to facilitate the signal processing and determine the flashing frequencies, as appropriate. In some example embodiments, the light source 40 includes a system having one or more flashing LEDs, which may be of different colours, and thereby provides different colours of flashing illumination. It can be appreciated that flashing may decrease energy consumption of the power source 44 when compared to continuous illumination.

In some example embodiments, the light source 40 can increase the intensity of illumination based on the received signal which is applied for activation of the light source 40. The intensity of illumination of the light source 40 is proportional to the received signal from the motion detector 48 or switch 46. The faster the movement, the greater the intensity of illumination. Thus, others may be aware of the general speed of the user by gauging the intensity of illumination.

In some example embodiments, the wavelength of the light source 40 increases based on the received current. The wavelength of the light source 40 is generally proportional to the received signal from the motion detector 48 or switch 46. From example, a faster movement results in the light source 40 emitting colours in the higher wavelength spectrum, for example in the orange/red spectrum. Similarly, a slower movement results in the light source 40 emitting colours in the lower wavelength spectrum, for example in the violet/blue spectrum. In other example embodiments, the properties of spectrum may be reversed, with the faster movement resulting in the violet/blue spectrum. In some example embodiments, the light source 40 is limited to emitting specified colours, for example green, yellow, and red, to generally correspond fast, slow, and stop, respectively.

Referring to FIG. 5, the illuminator device 14 is attached or adapted for attachment to the safety helmet 12 with an adhesive 70. A suitably strong adhesive tape or glue can be used. A foam insert 72 such as EVA foam may also be positioned between the illuminator device 14 and the safety helmet 12 to assist in conforming the shape of the casing 38 to the shape of the safety helmet 12.

Another transparent shell (not shown) is used to cover the safety helmet system 10 for protection of the illuminator device 14 while still permitting illumination to emit from the helmet system 10. The transparent shell generally conforms to the shape of the exterior shell 16 assembled with the illuminator device 14.

Although point-to-point optical fibers have been described, it can be appreciated that other types of optical fibers may be used, such as side light optical fibers, which allows illumination through the cladding. Combinations of point-to-point and side light optical fibers can also be used.

It can be appreciated that the fiber optic cables are not limited to the positioning shown in FIGS. 1 to 4. For example, the fiber optic cables may be woven in and out through the air holes 22 (or other holes) of the exterior shell 16, so long as the fiber optic cables illuminate and are viewable from the exterior of the safety helmet 12.

In some example embodiments, the motion detector 48 is not contained within the casing 38 but may be held or carried by the user, or embedded in the user's apparel or sporting equipment. The motion detector 48 would transmit using a wireless control signal to the switch 46 for activation of the light source 40. The control signal may also indicate a speed of travel to control the frequency of flashing of the light source 40. For example, the control signal can be a digital or logical signal which includes information which indicates the speed of travel.

While the invention has been described in detail in the foregoing specification, it will be understood by those skilled in the art that variations may be made without departing from the scope of the invention.

1-21. (canceled)

22. An illuminator device for a safety helmet, the safety helmet having an exterior surface, the illuminator device comprising:
a fiber optic cable having two ends and adapted for mounting on the safety helmet so as to illuminate an exterior of the safety helmet;
a light source coupled to a light interface, the light interface connected to one end of the fiber optic cable, the light source being activateable;
a power source electrically connected to the light source; and
a motion detector for detecting motion or motion of a preselected type or amount and for providing a signal to activate the light source upon detection of motion or the preselected motion, wherein the light source includes an optical property which is activated proportional to the amount of motion detected by the motion detector, wherein the light source is a flashing light source which is activated to flash at a frequency proportional to the amount of motion detected by the motion detector.

23. The illuminator device of claim 22, wherein the motion detector detects a speed of motion, and the signal provided is proportional to the speed of motion.

24. The illuminator device of claim 22, wherein an illumination intensity of the light source is proportional to the amount of motion detected by the motion detector.

25. The illuminator device of claim 22, wherein the motion detector determines whether a predetermined motion threshold has been reached, said signal being provided when said motion threshold is reached during motion of the illuminator device.

26. The illuminator device of claim 22, wherein the motion detector includes an accelerometer.

27. The illuminator device of claim 22, wherein the motion detector includes an optical sensor.

28. The illuminator device of claim 22, wherein the fiber optic cable includes a plurality of optical fibers and said fiber optic cable is adapted for mounting along the exterior surface of the safety helmet.

29. The illuminator device of claim 28, wherein the optical fibers each have respective ends remote from said light source which are located at different positions along a length of the fiber optic cable.

30. A helmet system, comprising:
a safety helmet including an exterior shell having an exterior surface; and
an illuminator device including:
a fiber optic cable having two ends and mounted on the safety helmet so as to illuminate an exterior of the safety helmet,
a light source coupled to a light interface, the light interface connected to one end of the fiber optic cable, the light source being activateable,
a power source electrically connected to the light source, and
a motion detector for detecting motion or motion of a preselected type or amount and for providing a signal to activate the light source upon motion detection or detection of the preselected motion, wherein the light source includes an optical property which is activated proportional to the amount of motion detected by the motion detector, wherein the light source is a flashing light source which is activated to flash at a frequency proportional to the amount of motion detected by the motion detector.

31. The helmet system of claim 30, wherein the motion detector detects a speed of motion, and the signal provided is proportional to the speed of motion.

32. The helmet system of claim 30, wherein an illumination intensity of the light source is proportional to the amount of motion detected by the motion detector.

33. The helmet system of claim 30, wherein the motion detector determines whether a predetermined motion threshold has been reached, said signal being provided when said motion threshold is reached during motion of the helmet system.

34. The helmet system of claim 30, wherein the fiber optic cable is mounted along the exterior surface of the exterior shell.

35. A method of illuminating a safety helmet having an exterior surface, the safety helmet having a fiber optic cable having two ends mounted thereon so as to illuminate an exterior of the safety helmet, the method comprising:
detecting motion or motion of a preselected type or amount of the safety helmet and providing a signal upon detection of motion or motion of the preselected type to activate a switch to an active state; and
activating a light source coupled to a light interface connected to one end of the fiber optic cable, said light source being activated when said switch is in the active state, said light source including an optical property which is activated proportional to the amount of motion detected by the motion detector, wherein the light source is a flashing light source which is activated to flash at a frequency proportional to the amount of motion detected by the motion detector.

36. The method of claim 35, wherein the step of detecting includes detecting a speed of motion, and the signal provided is proportional to the speed of motion.

37. The illuminator device of claim 22, wherein the light source is activated at at least an illumination intensity which provides illumination for warning others.

38. The helmet system of claim 30, wherein the light source is activated at at least an illumination intensity for which provides illumination for warning others.

39. The method of claim 35, wherein the light source is activated at at least an illumination intensity which provides illumination for warning others.

40. The helmet system of claim 30, wherein the fiber optic cable includes a plurality of optical fibers and said optical fibers each have respective ends remote from said light source which are located at different positions along a length of the fiber optic cable.

41. The method of claim 35, wherein the fiber optic cable includes a plurality of optical fibers and said optical fibers each have respective ends remote from said light source which are located at different positions along a length of the fiber optic cable.
